(19) United States
(12) Patent Application Publication
(10) Pub. No.: US 2002/0194080 A1
(43) Pub. Date: Dec. 19, 2002

(54) Internet cash card

(76) Inventor: Ronald Lourie, West Des Moines, IA (US)

Correspondence Address: DAVIS, BROWN, KOEHN, SHORS & ROBERTS, P.C., THE FINANCIAL CENTER, 666 WALNUT STREET, SUITE 2500, DES MOINES, IA, 50309-3993, US

(21) Appl. No.: 09/884,868

(22) Filed: Jun. 19, 2001

(51) Int. Cl. G06F 17/60

(52) U.S. Cl. 705/26

(57) ABSTRACT

A card is provided that has a predetermined denominational value and an indicia of identification associated therewith. The card is issued to a consumer in exchange for payment by the consumer of an amount equal to the predetermined denominational value associated with the card. The consumer presents the card to a merchant as payment to the merchant for goods or services, where the amount of the payment to the merchant is less than or equal to the predetermined denominational value associated with the card. The card is verified by transmitting the indicia of identification and the amount of the payment made by the consumer to the merchant, to a card issuing authority. The card issuing authority issues an approval code and the merchant. Then the merchant completes the transaction by providing to the consumer the goods or services that the consumer previously requested by presenting the card to the merchant. Funds are transferred from the card issuing authority to the merchant in the amount of the payment from the consumer to the merchant.

### BACKGROUND OF THE INVENTION

The present invention relates to an anonymous method of transaction. In particular, to a method of anonymous transaction that uses an anonymously issued card of a predetermined transactional value for presentation to a merchant in exchange for goods and services.

It is hard to exaggerate or overemphasize the revolutionary changes wrought on the world by the Internet. According to the Internet strategy firm Nua, the number of people online worldwide jumped from 16 million in 1995, nearly all of them located in the United States and Canada, to over 407 million in November, 2000. The number of online users in the United States stood at over 153 million in November 2000, and still growing.

Perhaps the greatest and most profound changes resulting from the Internet explosion involve the growth of electronic commerce. A report of the United States Department of Commerce on the emerging digital economy, published in June 1999, noted estimates in 1997 that Internet retailing would reach $7 billion by the year 2000—a level actually surpassed by at least 50% in 1998. The same report predicted online retail trade would reach $40-$80 billion by 2002. Forester Research estimates online sales for 2000 reached $300 billion. Unquestionably, the credit card comprises the enabling vehicle for the explosion in online retail trade.

Credit card providers like MasterCard and Visa, in cooperation with banks and merchants have rapidly developed the infrastructure needed to conduct business on the Internet. This infrastructure has taken a number of forms. In general, the process attempts to incorporate online transactions into the existing conventional credit card system. Thus, an understanding of online transactions requires an understanding of the standard system.

A conventional credit card transaction starts when a customer presents a credit card to a merchant for payment of goods or services. The merchant runs the credit card through a point of sale unit, which transmits basic information about the transaction to an acquiring or merchant bank. Merchants maintain a relationship with an acquiring bank, whereby that bank handles the merchant's credit card transactions. Normally, point of sales units attempt to immediately obtain approval or denial of the transaction, and in the former case they communicate the actual sales draft at a later time.

The acquiring bank then routes the transaction to the card-issuing bank, whereby the credit card number identifies the type of credit card, the bank that issued the card, and the cardholder's specific account. It should be noted that some credit cards like Discover and American Express, are not associated with card issuing bank, rather the card-issuing company itself performs the authorization and capture steps itself. In any event, the issuing bank/company determines whether the cardholder's credit balance will cover the transaction, and issues either an authorization or denial code back to the acquiring bank. Typically, where the issuing back authorizes the transaction, the issuing bank will place a hold on the cardholder's account in the amount of the transaction, but would normally complete the transaction at a later point in time. The acquiring bank then communicates the code received from the issuing bank back to the point of sale unit (each point of sale unit has a unique terminal ID that allows the acquiring bank to properly route communications). If the issuing bank authorized the transaction, the point of sale unit will print a sales draft (or will allow the cash register to print the draft), the customer signs the draft which obligates the customer to repay the issuing bank the amount of the transaction. From the point of view of the customer, the transaction is complete, however, from the point of view of the financial institutions and the merchant involved the transaction is not complete due to the fact that no funds have actually changed hands.

At a later point in time, usually at night at the close of the merchant's business day, the merchant will review the authorizations stored in the point of sale unit and capture or transmit them back to the acquiring bank for deposit. The acquiring bank then performs an interchange with the card issuing bank(s) for each authorized sales draft. The card-issuing bank transfers the amount of the sales draft, withholding a portion of the amount as a processing fee, to the acquiring bank. The acquiring bank then transfers all of the funds from the merchant's sales drafts into to the merchant's bank account, withholding a portion of the amount as a processing fee. At this point the merchant's bank account is credited to reflect the days sales with funds from the credit card issuing bank. The credit card issuing bank collects the funds from the customer when the customer pays his/her monthly bill.

In order to transpose the existing credit card infrastructure to the Internet, companies like CyberCash and VeriFone have extended the existing communications networks built by the likes of MasterCard and Visa to enable extensive use of credit cards on the Internet. The same basic components still exist, except that the merchant's store is replaced with the merchant's web site. The merchant still has a merchant bank that handles the merchant's accounts. The transaction still involves an acquiring bank, which is sometimes called a processor or a clearinghouse. Again, the acquiring bank, or processor, specializes in managing credit transactions for the merchant. The issuing bank, or card-issuing bank, is the bank that issued the credit card to the consumer. An additional component required for Internet credit card transactions comprises the software that handles the communications between the merchant's web site and the acquiring bank (or processor) and the card-issuing bank.

The software used with Internet credit card transactions takes on a variety of forms. In general the software is the tool that enables processing the credit card online. Most credit card processing software will work directly from the merchant's Web site, and may also partially reside on the customers computer. The software will communicate directly with a gateway site that houses a secure server that will communicate between the merchant's Web site and the acquiring bank (or processor), merchant bank, and if necessary the credit card issuing bank. The software will use some form of encryption, typically a public/private key system like DES/RSA, to ensure security in the transaction.

For example, an Internet credit card transaction using the CyberCash software system would include the following steps. The process would begin with a consumer selecting an item from a merchant's Web site, and clicking on the PAY button. CyberCash Wallet software residing on the consumer's computer, typically registered as a helper application with the consumer's Internet browser program, would allow the consumer to select the means of payment consisting of credit card payment in this instance. The consumer would initiate the transaction thereby requesting approval for the charge. The software encrypts the payment/order information to maintain privacy, and transmits the information to the merchant's Web site.

The merchant's Web site also includes specialized software distributed by CyberCash called Secure Merchant Payment System (SMPS), which interfaces with the software residing on the consumer's computer on one end and interfaces with the CyberCash secure gateway servers on the other end. The merchant's SMPS software receives the encrypted information from the consumer's computer over the Internet, and adds the merchant's identification information and passes the payment/order information on to the CyberCash secure gateway servers. Again, the system maintains security by encrypting the information for a second time. The gateway server receives the charge authorization request, decrypts it, and authenticates both the customer's and the merchant's identification information. Pending successful authentication the gateway server then encrypts the information, this time using the authenticating bank's encryption information, and sends the information to the acquiring bank over conventional credit card network system. At this point the transaction proceeds in the manner described hereinabove with regard to a conventional credit card transaction.

In other words, the acquiring bank forwards the payment request to the card issuing bank/company. The issuing authority then either sends an approval or denial code to the acquiring bank in the conventional manner, and the acquiring bank then passes that information to the gateway server. Back on the Internet, the gateway server passes the information to the merchant's SMPS software, which then passes the information to the consumer's computer thereby completing the transaction, at least from the consumer's point of view. The entire Internet credit card transaction up until this point can take as little as 10-20 seconds to complete.

Of course, just as in the process for a conventional credit card transaction, in the Internet transaction at some point in time the transaction funds need to transfer from the card-issuing bank to the merchant bank. Thus, upon confirmation that the goods have shipped to the consumer the capture step takes place. Additionally, the systems also make provisions for online refunds.

Others like CyberSource, Verifone, ClearCommerce, and Visa/MasterCard through their joint Secure Electronic Transaction (SET) system provide means to conduct credit card transactions over the Internet. While the methods may vary, they all share the same common characteristics. Regardless of the system, security is of primary importance and the systems are highly complex in nature. Indeed, the summary provided hereinabove only begins to describe the full nature of credit card transactions.

Despite the admirable and elaborate measures employed to enable secure Internet credit card transactions, the level of fraud on the Internet appears up to the challenge of overcoming all of these measures. For example, ZDNET reported that hackers broke into Western Union's Web site and gained access to 16,000 credit card numbers, and MSNBC reported an extortion plot by a hacker who stole 60,000 credit cards numbers from an Internet payment-processing firm. In another incident, a bug in shopping cart software called “PDG” exposed customer records on thousands of Web sites, and cost thousands of dollars in fraudulent charges to credits, all of this despite nearly immediate FBI warnings of the problem. Making matters worse, the FBI estimates that up to 70 percent of Internet fraud results from inside information, a fact that makes it more than likely that much Internet fraud and security breaches go unreported. Many companies simply do not want to admit to consumers that as the gatekeepers of Internet security they cannot even secure their own systems from their own employees, let alone from outside attacks.

Unfortunately, the loss of credit card numbers can often lead to an even worse infringement on a consumer's security. With access to credit card numbers comes access to all sorts of personal information that in the hands of the unscrupulous can cause even further grief to a consumer. The rise of identity theft, in many cases stems from unauthorized access to the type of information maintained by those involved in credit card transactions, and in particular Internet credit card transactions.

Notwithstanding the misfortune associated with lost or stolen credit cards, merely using a credit card at all caries with it substantial risk of the loss of personal information. Credit card companies and merchants can acquire extensive information about the buying habits of consumers through information about the use of credit cards. In addition, these entities frequently provide this information to others for marketing and promotional purposes. The gathering and sharing of this type of information in itself represents a threat to an individual's privacy and security.

Accordingly, a need exists for a method of credit card transaction that provides for more security and reduces transactional complexity without negatively impacting the general ease of use of credit cards.

### SUMMARY OF THE INVENTION

An object of the present invention comprises providing an anonymous method of transaction.

These and other objects of the present invention will become apparent to those skilled in the art upon reference to the following specification, drawings, and claims.

The present invention intends to overcome the difficulties encountered heretofore. To that end, a card is provided that has a predetermined denominational value and an indicia of identification associated therewith. The card is issued to a consumer in exchange for payment by the consumer of an amount equal to the predetermined denominational value associated with the card. The consumer presents the card to a merchant as payment to the merchant for goods or services, where the amount of the payment to the merchant is less than or equal to the predetermined denominational value associated with the card. The card is verified by transmitting the indicia of identification and the amount of the payment made by the consumer to the merchant, to a card issuing authority. The card issuing authority issues an approval code and the merchant. Then the merchant completes the transaction by providing to the consumer the goods or services that the consumer previously requested by presenting the card to the merchant. Funds are transferred from the card issuing authority to the merchant in the amount of the payment from the consumer to the merchant.

### BRIEF DESCRIPTION OF THE DRAWINGS

FIG. 1 is a block diagram of transactional steps of the method of the present invention.

FIG. 2 is a block diagram of the steps involved in making a purchase using the method of the present invention.

FIG. 3 is a simplified block diagram of the steps involved in making a purchase using the method of the present invention.

FIG. 4 is a block diagram of the steps involved in making an online purchase using the method of the present invention.

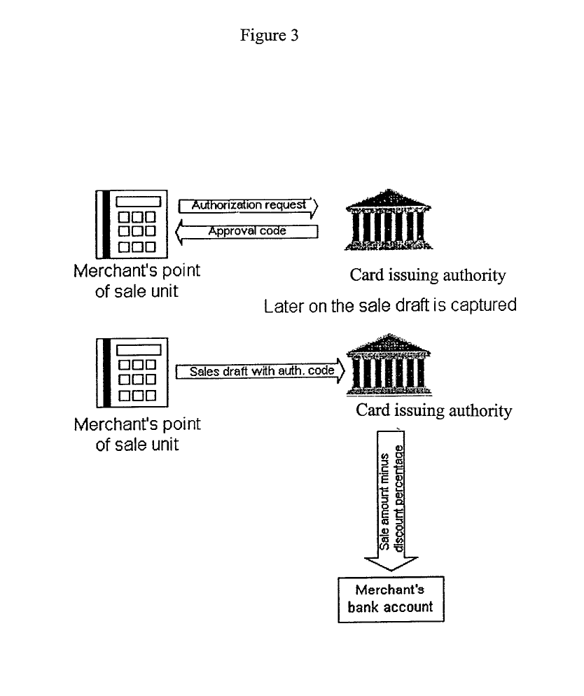

FIG. 3 is a simplified block diagram of the steps involved in making an online purchase using the method of the present invention.

### DETAILED DESCRIPTION OF THE INVENTION

The present invention involves an anonymous transaction method that enables an individual to make purchases in a secure manner, with minimal risk, and without sacrificing convenience. The principle instrument of the method comprises a card, or token, that for the sake of convenience can resemble a conventional credit card. An issuing authority would arrange for the manufacture of the card, or token, and generally control the transactional use of the card. The card would carry an indicia of identification that would uniquely identify the card. For example, the indicia could comprise a multiple digit number, alphanumeric symbol, or any other similar identifier. The card can also include an electronic strip containing the indicia electronically coded that will enable use of the card with conventional point of sale units, or ATM machines, and the like. In addition, the card would be worth a predetermined value. For example, the cards could carry incremental predetermined denominational values of $10, $20, $40, or $1,000 or more. The indicia of identification would allow for identification of the incremental value of each individual card, and identify a unique account for each individual card. Of course, it would be necessary to encrypt or otherwise disguise the coding of the value of the card to prevent manipulation of the indicia to inflate the value of the card.

Traditional merchants like grocery stores, convenience stores, banks, or retailers could provide the cards to individuals on an as needed basis. Furthermore, vending machines could dispense the cards. An individual would purchase a card in the desired denomination, preferably in cash. The transaction would involve only the exchange of the card and the payment, with no communication of personal information. In other words, the transaction is completely anonymous. The merchant (or vending machine) receives the cash, and the individual receives the card. At a later point in time, using conventional means of exchange, the card issuing authority would receive the money from the merchant or collect the money from the vending machine. The merchant, or vending machine, would also communicate to the card issuing authority the indicia of the card to establish which cards have entered the stream of commerce and which remain unsold.

Alternatively, the individuals could purchase the cards with a credit card. The transaction would proceed in a conventional manner, except that the card issuing authority would not record or even need to receive the credit card information. The merchant selling the card would process the credit card transaction in the manner describe hereinabove, the merchant would issue the card to the individual after receiving approval. Then at a later point in time funds would be transferred form the merchant's bank to the card issuing authority as previously disclosed. The individuals credit card would merely record that a transaction took place and not record any information that would allow for tracing an individual card, or token, to a specific individual.

The individual now in possession of the card, or token, could then use the card for any purchase they like. The transaction would merely involve presenting the card, or token, to a merchant either in person, or over the Internet by entering the indicia of identification. This information would be transmitted to the card issuing authority by the merchant either using a conventional point of sale unit, or through software operating to connect the merchant's computer to the card issuing authorities secure gateway server. The card issuing authority would then verify that the account identified by the indicia of identification contains funds sufficient to complete the transaction, places a hold on the funds, and sends an approval code to the merchant. The merchant then completes the transaction by performing the services or providing the goods requested by the consumer.

Alternatively, the transaction could take place using the existing credit card network. In this case the card issuing authority would effectively take the place of the card-issuing bank.

Under either method, at some point in time, preferably at a later point in time, the transaction would be completed by the card issuing authority transferring funds to the merchant's bank in an amount equal to the amount of purchase(s). This step could be completed automatically by the card issuing authority, or in response to a request from the merchant as in the conventional credit card transaction capture procedure.

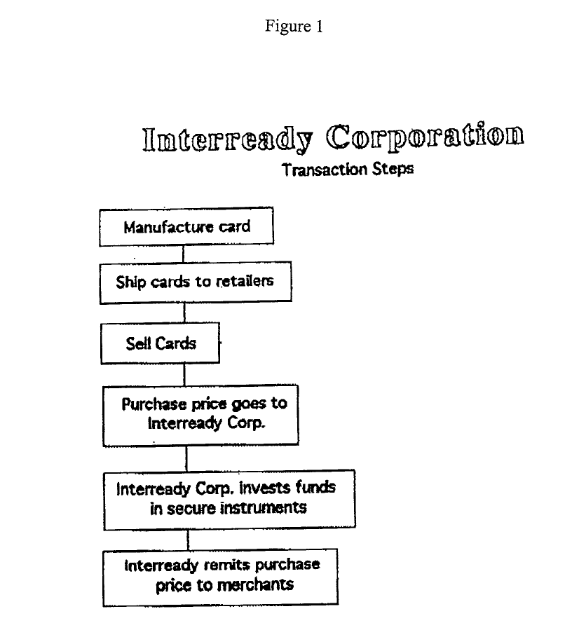

In the figures, FIG. 1 generally describes the steps in the method of the present invention. The first step involves manufacturing the cards, or tokens. Next the cards are shipped or provided to participating retailers or vending machines for distribution to the public. The cards are then sold to the general public in an anonymous transaction. After the cards have been sold the purchases price is transmitted to the card issuing authority. The card issuing authority can then invest the funds in conventional interest bearing investments of its choice. Then upon use of the cards by consumers the card issuing authority will remit payment to merchants commensurate with the amount of the transaction.

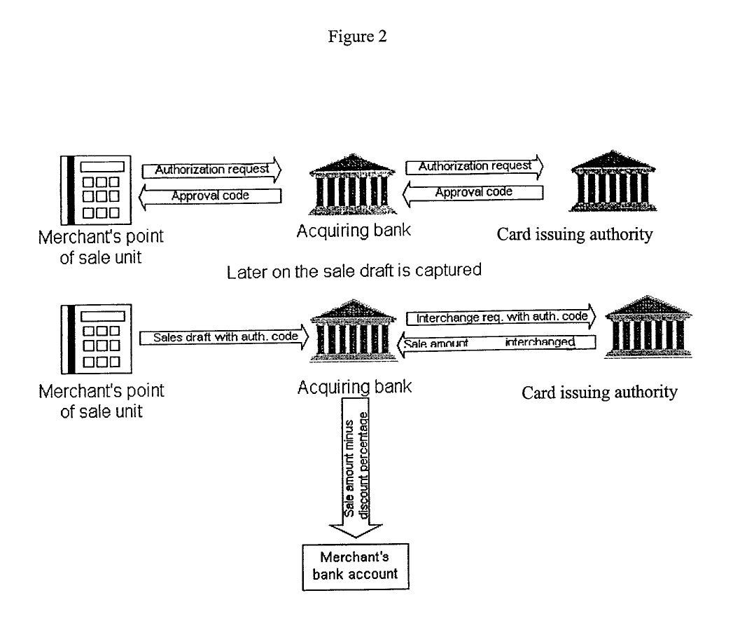

FIGS. 2-5 describe the various method of processing consumer transactions using the card, or token. In particular, FIG. 2 shows the method for use of the card through a merchant's point of sale unit and using the conventional credit card like transactional process. This reflects an in person purchase using the card. The merchant's point of sale unit would transmit the card's indicia of identification to the merchant's acquiring bank. The acquiring bank would then relay the authorization request to the card issuing authority. Upon verification the card issuing authority would transmit an approval code to the merchant's acquiring bank, and the acquiring bank would relay the code to the merchant's point of sale unit. The merchant then would complete the transaction by providing the goods or services to the consumer.

At a later point, the remainder of the transaction is culminated. The merchant's point of sale unit would transmit to the merchant's acquiring bank the sales draft(s) along with the approval codes. The acquiring bank then would request an interchange of funds from the card issuing authority, and provide the approval code received from the merchant. The card issuing authority would then transfer the funds to the merchant's acquiring bank, which would then forward the money to the merchant's bank. It is contemplated that the method of the present invention could eliminate the interchange fee charged to the merchant's acquiring bank, however, this is not necessarily the case. Because the card issuing bank receives the money for the card or token prior to the merchant's transactions the card issuing bank can invest the money and acquire interest payments that could fund the method.

The method depicted in FIG. 2 takes advantage of the existing credit card systems and networks; however, the method of the present invention is not so limited. FIG. 3 shows the method of the invention whereby the merchant's acquiring bank is eliminated. In this embodiment merchant's acquiring bank is replaced with the card issuing authority. Thus, the merchant would communicate directly with the card issuing authority.

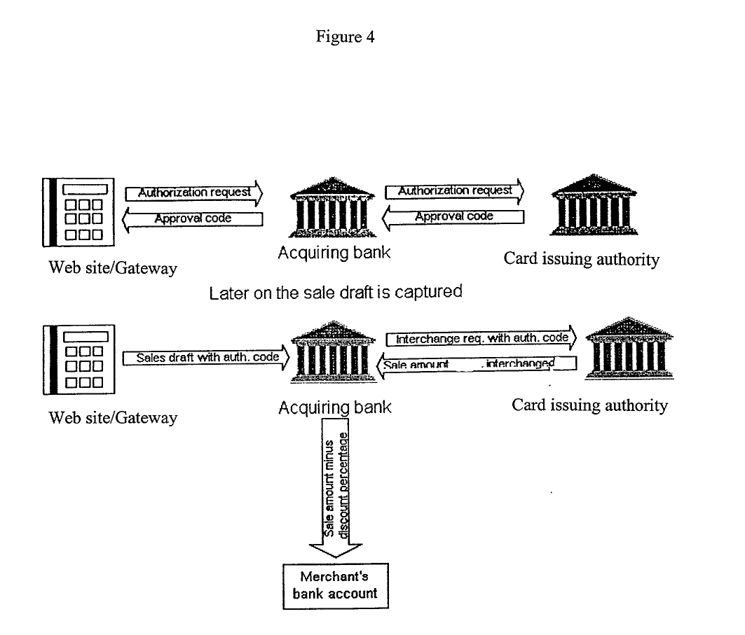

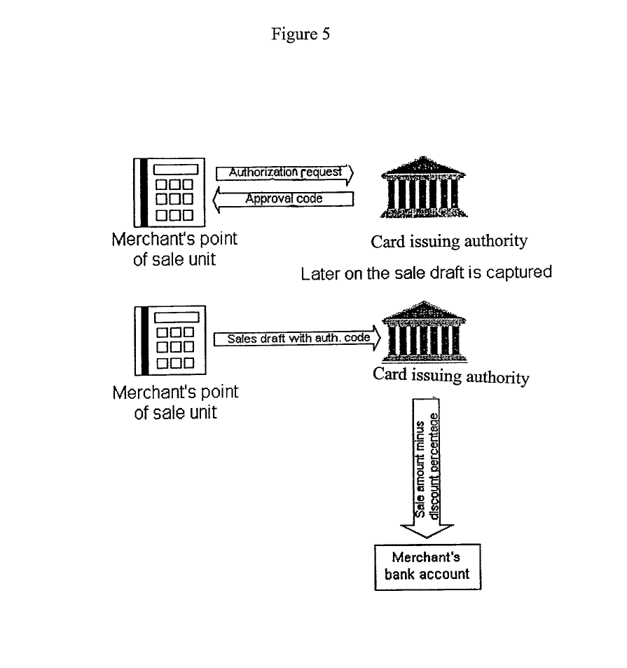

FIGS. 4-5 show the method of the present invention for use with Internet transactions. The method for the most part makes use of the same conventional systems utilized for Internet credit card transactions. In particular, FIG. 4 shows that the method essentially takes place in the manner described above except that the merchant's point of sale unit is replaced with the merchant's Web site and secure gateway server. As shown in FIG. 5, the method does not need to utilize the existing credit card, or credit card like, system. The transaction can be completed by direct communication between the merchant's Web site and secure gateway server and the card-issuing bank.

The use of the card, or token, substantially eliminates the risk and drawbacks of the conventional credit card, while still preserving the ease of use. Due to the anonymous nature of the card, the consumer can use the card for any goods and services without concern about compromising their anonymity to anyone. In addition, by pre-selecting the denomination of the card the consumer and the card issuing authority can limit the liability and risk associated with the loss of the card. Also, by pre-selling the cards the card issuing authority can eliminate or substantially reduce the cost of using the cards when compared to the cost associated with conventional credit card transactions. The use of the cards can also provide access to the credit card systems to those who otherwise could not obtain conventional credit cards. A large number of people do not have the ability to receive a credit card, or do not have a credit history that would allow them to participate in the credit card system. These people would, however, be able to secure a card of the type contemplated herein and use it to participate in Internet transactions that essentially require the use of a credit card.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. An anonymous method of transaction, said method comprising:
providing a card of predetermined denominational value having an indicia of identification associated with said card and said value;
issuing said card to a consumer anonymously in exchange for payment by said consumer of said predetermined denominational value associated with said card;
presenting said card to a merchant as payment to said merchant for a transaction of goods or services, wherein said payment by said consumer to said merchant is less than or equal to said predetermined denominational value associated with said card;
verifying said card by transmitting said indicia of identification and the amount of said payment by said consumer to said merchant, from said merchant to a card issuing authority;
issuing an approval code from said card issuing authority to said merchant;
completing said transaction by said merchant providing said good or services to said merchant; and
transferring funds from said card issuing authority to said merchant in the amount of said payment from said consumer to said merchant.

2. The invention in accordance with claim 1 wherein said merchant has a Web site and said transaction takes place through said merchant's Web site.

3. The invention in accordance with claim 1 wherein said step of verifying said card by transmitting said indicia of identification from said merchant to a card issuing authority and said step of issuing an approval code from said card issuing authority to said merchant, further comprises first transmitting said indicia of identification and the amount of said payment from said consumer to said merchant, from said merchant to a merchant's acquiring bank and then to said card issuing authority, and then issuing an approval code from said card issuing authority to said merchant's acquiring bank and then to said merchant.

4. The invention in accordance with claim 3 wherein said step of transferring funds from said card issuing authority to said merchant in the amount of said payment from said consumer to said merchant, further comprises first transferring said payment from said consumer to said merchant to said merchant's acquiring bank and then to said merchant.

5. The invention in accordance with claim 1 further comprising the step of deducting the amount of said payment from said consumer to said merchant, from said predetermined value of said card upon issuing said approval code.
